(19) United States
(12) Patent Application Publication
(10) Pub. No.: US 2024/0271994 A1
(43) Pub. Date: Aug. 15, 2024

(54) Handheld Gas and Vapor Analyzer

(71) Applicant: CAM2 TECHNOLOGIES, LLC, Danbury, CT (US)

(72) Inventors: Gregg Ressler, Shelton, CT (US); Jonathan A Frattaroli, Danbury, CT (US); David W Schiering, Danbury, CT (US); John A Seelenbinder, Waterton, CT (US); Kenneth C Schreiber, Newton, CT (US); Mark Stoltze, Danbury, CT (US); James McWilliams, Danbury, CT (US); Anthony W DiDomenico, Danbury, CT (US)

(21) Appl. No.: 18/569,035

(22) PCT Filed: Jun. 11, 2022
(86) PCT No.: PCT/US22/33157

§ 371 Date: Dec. 11, 2023

Related U.S. Application Data
(60) Provisional application No. 63/209,956, filed on Jun. 11, 2021.

(51) Int. Cl. G01J 1/02; G01J 3/02; G01J 3/453; G01N 21/35; G01N 21/3504

(52) U.S. Cl. CPC G01J 1/0233; G01J 3/0208; G01J 3/021; G01J 3/027; G01J 3/453; G01N 21/3504; G01N 2021/3595; G01N 2201/0221

(57) ABSTRACT

A gas and vapor analyzer system and method of detecting a gas or vapor sample are provided. An FTIR spectroscopy system of an analyzer system comprises an interferometer adapted to modulate an excitation signal. A gas cell is adapted to receive the modulated excitation signal and focus the modulated excitation signal within the gas cell via an input lens. An off-axis multiple reflection geometry is adapted to receive the focused modulated excitation signal and pass the focused modulated excitation signal through a gas or vapor phase specimen via a plurality of beam paths skewed relative to a longitudinal axis of the cell to generate an optical sample signal. An exit lens is adapted to direct the optical sample signal from the gas cell to an IR radiation detector, and a controller is adapted to identify a detected gas and vapor sample based on the optical sample signal.

### CROSS-REFERENCE TO RELATED APPLICATIONS

This application claims the benefit of U.S. provisional application No. 63/209,956, filed Jun. 11, 2021, which is hereby incorporated by reference as though fully set forth herein.

### BACKGROUND

### a. Field

This disclosure concerns the optical measurement and identification of unknown gas samples.

### b. Background

The detection and identification of gas and vapor phase materials is important to protect the health of first responders, the general public, and military personnel. Vapors may be present that are toxic and dangerous to health. Responders employ various technologies to detect these chemical threats. Most suffer from a lack of specificity to identify a broad range of materials. Several different technologies provide for the detection of relatively few gases in a handheld configuration. These technologies include photoionization detectors (PID), ion mobility spectrometers (IMS), surface acoustic wave (SAW) sensors, and flame emission devices. These devices do not provide the breadth of chemical identification that is possible with infrared (IR) spectroscopy. IR spectroscopy is well suited to identifying unknown materials. The IR absorption spectrum of a molecule is a physical constant and very sensitive to molecular structure. The IR spectrum is highly specific and is considered a fingerprint of a molecule. With few exceptions, all vapor phase molecules exhibit an IR absorption spectrum. Therefore, IR spectroscopy can potentially identify a much broader range of molecules with higher confidence. There is currently no commercial, at-scene, handheld FTIR instrument for the instantaneous identification of vapor phase chemicals.

The following references related to gas and vapor analyzers are incorporated by reference as if fully set forth herein.

| | | |
|---|---|---|
| U.S. Pat. No. 4,383,762 | May 1983 | Burkert |
| U.S. Pat. No. 5,914,780 | June 1999 | Turner, et al. |
| U.S. Pat. No. 10,451,540 B2 | October 2019 | Baum, et al. |
| U.S. Pat. No. 9,279,721 B2 | August 2016 | Krause, et al. |
| WO 2016/118431 A1 | January 2016 | |
| EP 0 596 605 A1 | August 1993 | |

J. U. White, “Long Optical Paths of Large Aperture,” Journal of the Optical Society of America, 32: 285-288 (1942)
D. Horn and G. C. Pimentel, “2.5-km Low-Temperature Multiple-Reflection Cell,” Applied Optics, 10(8): 1892-1898 (1971).
H. Rippel and R. Jaacks, “Performance Data of the Double Pendulum Interferometer,” Mikrochemica Acta, 95: 303-306 (1988).
P. R. Griffiths and J. A. De Haseth, Fourier Transform Infrared Spectrometry, 2nd ed., J. Wiley & Sons, Inc.: Hoboken, NJ. (2007).

### BRIEF SUMMARY

The disclosed Handheld Vapor and Gas Identifier provides an instrument to enable rapid, accurate, at-scene identification of vapors, such as by first responders. The identifier/analyzer can provide instantaneous information, thus removing fear, and facilitating informed decision making in an environment where the three primary questions regarding requisite vapor phase identification are: What is the threat? How is it going to hurt me? How fast is it coming at me? The device can be an intuitive product for operators with minimal chemistry background/instrument familiarity.

In one embodiment, a rugged, fully integrated, handheld Fourier Transform Infrared (FTIR) spectrometer, with a long path, multi-reflection gas cell for analysis and identification of unknown vapor phase compounds is provided. An integrated PID provides complementary information for gas detection and the potential to estimate gas and vapor concentration. The spectrometer is ergonomically designed to deliver rapid, accurate results. The spectrometer is battery powered and delivers real-time, at-scene threat identification and actionable intelligence. On-board software algorithms quickly identify unknown vapors, assisted by stored infrared spectral signatures of priority compounds. The possible identified components can be displayed on an integrated screen display with physical data concerning the material.

With a simplified/intuitive user interface (UI), an operator can select a discreet or continuous analysis modes, such as via a push of a button. An integral pump can fill the gas cell via an inlet port, and a button push completes the sample analysis in discreet sampling mode.

In a continuous survey mode, the instrument can freely run, sampling ambient vapor, and identifying vapor that is different from background.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a schematic view of an embodiment of a gas and vapor analyzer.

FIGS. 2A and 2B show field stop image patterns of an embodiment of a gas cell of a gas and vapor analyzer (A) and of a standard White Cell field stop image pattern (B).

FIGS. 3 and 4 show schematic views illustrating example field stop and pupil image patterns that may be used within a gas cell of a gas and vapor analyzer.

FIG. 5A shows the original field image pattern (34) created by the retroreflector mirror disclosed by Horn and Pimentel.

FIGS. 5B and 5C are two views of the field mirror in the present embodiment.

FIGS. 6A and 6B show schematic views of field lenses in place of standard input and output windows.

FIG. 7 is a schematic showing the electronics and methods for instrument control, power and output of an embodiment of a vapor and gas analyzer.

FIG. 8 is a flow chart showing a method of a single point measurement.

FIG. 9 is a flow chart showing a method of a continuous measurement using a reference or background measurement similar to the point measurement mode.

FIG. 10 shows line drawings of one example embodiment of a vapor and gas analyzer system employing a Fourier transform infrared spectrometer.

FIG. 11 demonstrates the specificity of infrared spectroscopy for identification of toxic gases by presenting spectra of (A) sulfur dioxide, (B) carbon monoxide, and (C) ammonia collected on the preferred embodiment of the gas and vapor identifier.

### DETAILED DESCRIPTION

The general scientific field of this disclosure is infrared (IR) spectroscopy, specifically Fourier transform infrared (FTIR) spectroscopy, used in the analysis of gases and vapors. The field is well known and described in the scientific literature, such as in Griffiths and De Haseth, included in the background intellectual property and other references. Some details of the operation and signal analysis of FTIR spectrometers are omitted and can be reviewed in the aforementioned reference and other references included.

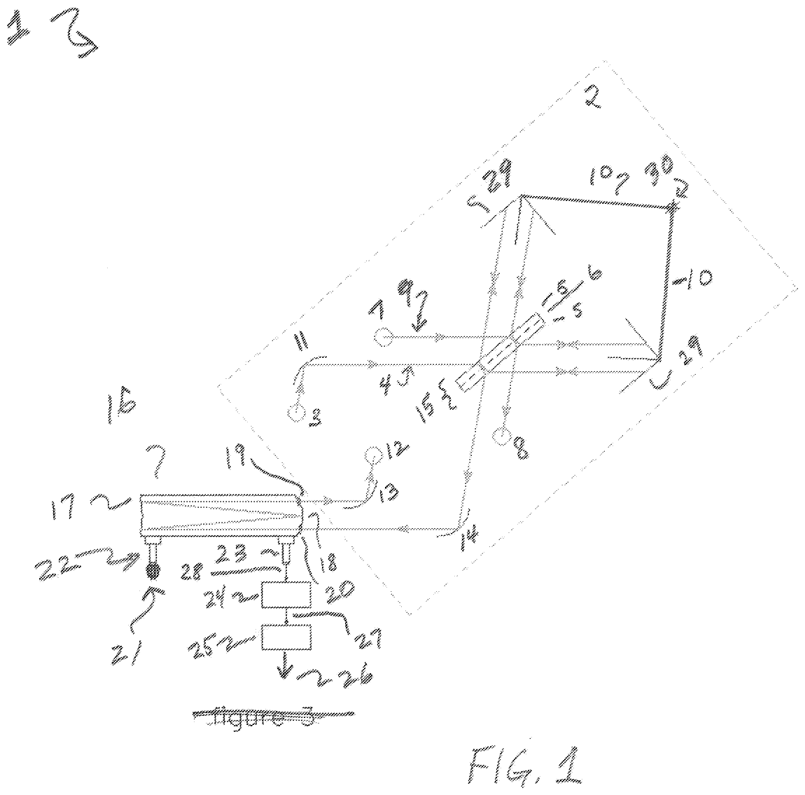

FIG. 1 shows a schematic view of an embodiment of a gas and vapor analyzer. In this view, the optics and mechanical hardware (1) are shown. In this embodiment, the analyzer employs an FTIR spectrometer (2) optically interfaced to a long-path gas cell (16). The interferometer (2) of the analyzer is a double pendulum and operates using rotary motion about a perpendicular axis (30) constrained by flex pivots. This type of interferometer is well-known in the art and is described in the included background intellectual property and other references—Rippel and Jaacks, Griffiths and De Haseth, or U.S. Pat. No. 4,383,762. This type of interferometer is advantageous because it is self-compensating for changes in optical alignment due to external perturbations that might be experienced by a handheld instrument. Other interferometers known in the art, such as those with linear actuators, can also be used.

The long-path gas cell (16), described in more detail below, provides a long optical pathlength, such as 2 meters (m), in a small volume, such as 37 milliliters (ml), in one embodiment. Ambient vapor (21) is drawn into the cell with an integrated pump (24). IR radiation is emitted from the IR radiation source (3) and the IR beam (4) is collimated and directed into the interferometer by a source optic (11). The IR beam (4) impinges upon the beamsplitter assembly (15), comprised by an IR beamsplitter coating (6) sandwiched between two compensator (5) optical plates. The IR beam is modulated by the motion of the retroreflectors (29), held in place by optical mounting (10), about the pivot point (30) of the interferometer. As is common in interferometers used in the FTIR field, the moving mirror position is tracked using a reference laser interferometer. In the disclosed embodiment retroflectors (29) comprise the moving mirrors in both the IR and reference laser interferometer. Monochromatic, collimated light output is provided by the reference laser (7). The laser beam (9) is modulated by the interferometer as described for the IR beam and detected by a laser detector (8). Gas lasers and solid-state lasers, including diode lasers, are known in the art. Also, the laser may have emission in the visible or IR regions. Appropriate laser detectors (8) are used as required by the laser wavelength.

Modulated IR radiation is directed to the long path gas cell by a pre-cell reflective optic (14). An input lens (20) to the long path gas cell (16) forms an image of the beamsplitter (15) at the gas cell objective mirror (17). The IR beam (4) undergoes multiple reflections in the cell (16) between the field mirror (18) and the objective mirror (17), interacting with the vapor molecules. The IR beam (4) exits the long path gas cell (16) through an output lens (19) and focused at the IR detector (12) element by a detector fore-optic (13). The output lens (19) forms an image of the objective mirror (17) on the detector fore-optic (13) to maximize the systemic optical image transfer.

The modulated IR beam signal is detected by a room temperature pyroelectric detector (12) such as a deuterated 1-alanine doped triglycine (DLATGS) or lithium tantalate (LiTaO₃) detector. More sensitive, cooled detectors such as mercury-cadmium-telluride (MCT) photoconductors are also envisioned and can be substituted for pyroelectric detectors. Photoionization (PID) detectors are well known for use in detecting the presence and quantifying concentrations of released gases or vapors. These detectors are primarily found as standalone instruments. The PID provides complementary data to FTIR identifications, can provide rapid indication (detection) of gas or vapor release, and through use of the vapor or gas identity provided by FTIR spectroscopic analysis, the PID can provide a concentration estimate. The vapor exhaust (28) from the pump (24) can be directed into a photoionization detector (PID, 25). Alternatively, the positions of the pump (24) and PID (25) may be juxtaposed, where the pump can draw the vapor from the gas cell, through the PID, and finally exhausted (26) to the ambient environment. Other embodiments of a gas and vapor identifier are known where the PID is not integrated into the system.

### Long Path Gas Cell

Limits of identification (LOI) for FTIR identification of unknown materials can be enhanced by increasing and/or maximizing the infrared beam path through the gas sample according to Beer's Law. Beer's law states that the absorbance (A) at any wavenumber is A=abc, where (a) is the specific absorptivity of the gas, (b) is the IR beam pathlength through the gas, and (c) is the concentration of the gas.

In various embodiments, the analyzer includes design of an integrated gas cell (e.g., a 2.0-meter path length gas cell). This results in an increased and/or maximized gas absorbance per Beer's law with a reduced and/or minimal gas sample volume. This can be accomplished by increasing and/or maximizing the path length through the cell, at minimum cell volume, thus increasing and/or maximizing the measured absorbence while reducing/minimizing the time required to fill the cell, resulting in decreased sample measurement and identification time. In these embodiments, the features enable continuous sampling and real-time sample identifications.

The gas cell design is based on the general multiple reflection geometry first proposed by White. The basic White cell optical design features two main mirrors, a field mirror at a beam input/proximal end, and a pair of objective mirrors at a far/distal end, separated by a base distance. The field mirror axis is colinear with the cell axis, such that its mirror center lies on the cell axis. The objective mirror pair centers are separated vertically by a specified distance. Both objective mirror pair axes are canted via a specified angle about their sag points inward toward the cell axis. This geometry drives the field stop pattern on the field mirror. An initial field stop image 0, is focused on the field mirror surface via relay optics from the interferometer. Successive field stop images are created on the field mirror via the objective mirrors for each intra-cell relayed field image. The field mirror in turn relays successive pupil images on the two objective mirrors alternating from top to bottom. In this fashion, the closed optical system within the cell creates a repeating succession of field and pupil images for the desired number of passes. The field stop geometry taught by White indicates adjacent rows and stacked columns disposed upon the field mirror, driving a field mirror face with large “dead” zones without field images. This large dead zone in turns results in a large internal diameter and corresponding large internal cell volume.

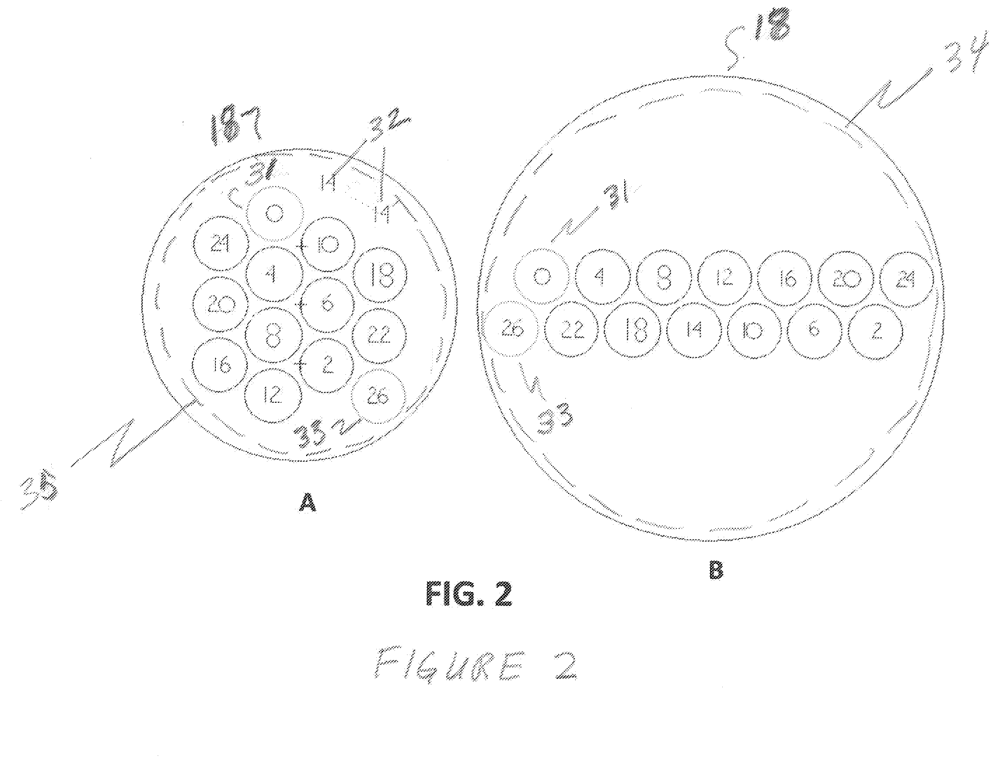

FIG. 2B shows the standard White Cell field stop image pattern (34) on the field mirror (18) for 26 passes. The field stop image labelled 0 (31) is the first image, and is formed by pre-cell relay optics, the field stop image labelled 26 (33) is the last image formed prior to the beam exiting the cell. This view clearly shows “dead” area on field mirror as a result of prior art field image progression. FIG. 2A also shows the field stop pattern for an embodiment of a gas cell for 26 passes with a field image nesting pattern (35) and reduced/minimal “dead” area, facilitating a 21% reduction in internal diameter in this embodiment. The field stop image labelled 0 (31) is the first image formed by the pre-cell reflective optic (14). The field stop image labelled 26 (33) is the last image formed prior to the beam exiting the cell. A retroreflector assembly (32), mounted on the field mirror at image 14, perpetuates the nesting pattern (35) and increases efficiency. This design feature will be discussed in more detail below. As described for this embodiment, the reduction/minimization of internal diameter corresponds to reduction/minimization of volume, drives high efficiency, and reduces/minimizes time to detect or identify an unknown.

A unique feature of the new cell design is a high volume/path length ratio, E=V/PL (efficiency) measured in liters per meter. In one embodiment, the cell produces 26 passes at a nominal base cell path of 3 inches, for a total path length of 2.0 m (6.53 feet), through a volume of 37 ml at an efficiency=0.019. This design facilitates use of small gas volumes for high sensitivity and accurate identification. Input volumes as small as 1 ml have resulted in sufficient analytical data for unknown identification.

To achieve a cell efficiency of 0.019, defined as a ratio of the gas cell volume to the gas cell pathlength, an embodiment of a field stop image design provides a nesting pattern (35) on the field mirror (18). This efficient nesting is achieved by two geometric design implementations. The first geometric consideration is staggering adjacent field image columns and rows to produce tight packing of images and minimal “dead” area on the field mirror (18). In various embodiments, the efficiency defined as the ratio of the gas cell volume to the gas cell pathlength may be less than 0.02, less than 0.03, or less than 0.04.

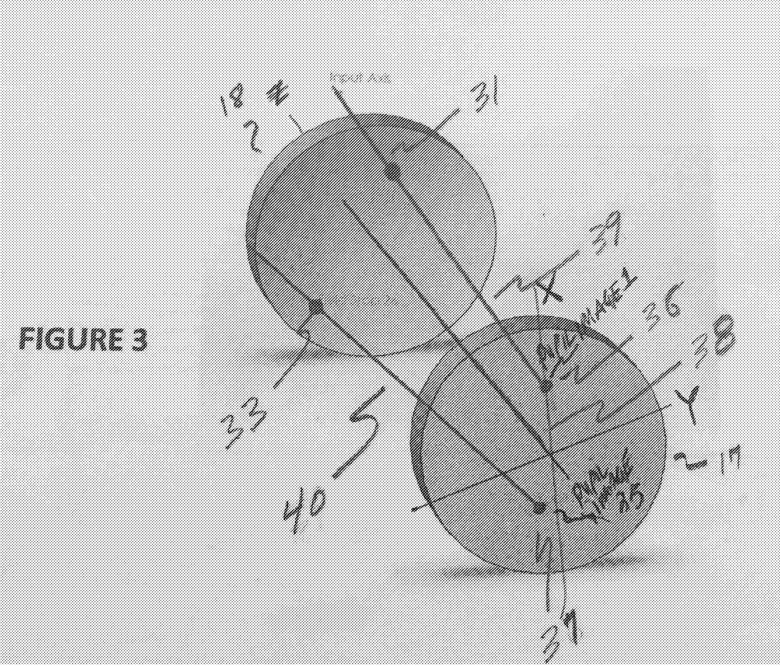

In reference to FIG. 3 and FIG. 4, the second geometric consideration is creating input and output beam axes to and from the cell that are skew to the cell centerline, as dictated by the geometry of the desired field stop nesting pattern (35). The gas cell input ray (39), originating at the IR source (3) and propagating from spectrometer (2), as the infrared beam (4), goes through field image 0 (31) of the field mirror (18), and enters the cell at an angle that is skewed from the gas cell centerline axis (38), and hits upper objective mirror (42) at pupil image 1 (36). The gas cell output ray (40) originating at pupil image 25 (37) on lower objective mirror (43), is also skewed from the gas cell centerline axis (38). Other rays that reflect between the objective mirror (17) and field mirror (18) are likewise skewed from the gas cell centerline axis (38). Introducing rays that are at an angle to the gas cell centerline axis (38) supports the nesting of the field stop images (35) and reduction of cell volume while retaining long optical path. Through purposeful manipulation of the design variables; cell field stop diameter, cell pupil diameter, cell base path length, cell total path length, intra-cell optical aberrations, interferometer target resolution, source diameter, source power, source temperature, detector diameter, detector D*, cell input and output beam geometry, efficient systemic optical throughput matching, minimization of total system path length, volume, and weight, a maximal field stop density on the field mirror is achieved without overlap or vignetting. This optical nesting pattern (35) reduces and/or minimizes the internal cell diameter thus enabling small internal volume, minimal overall cell size, and light weight.

FIG. 4 shows the unique, efficient field stop nesting (35) of 26 images on the field mirror (18). The images are nested such that there is reduced/minimal “dead” field mirror area while eliminating image overlap. The ray between each image number in the left view and the successive pupil number (41) in the right view, corresponds to a beam pass through the cell (16). The pupil images (41) lie above and below the cell axis (38) on the objective mirror (17) on top objective (42) and bottom objective (43). The objective mirror (17) comprises two mirrors canted in relation to each other. There is a top objective mirror (42) and lower objective mirror (43). Hence, in FIG. 3 and FIG. 4 field stop image 0 (31) creates a ray (39) proceeding to pupil image 1 (36) on top objective mirror (42). Pupil image 1 (36) from top objective mirror (42) creates a ray proceeding to field image 2 (60), and so on back and forth between the field mirror and objective mirror until pupil image 25 (37) on the bottom objective mirror (43) creates ray 26 (40) proceeding to field image 26 (33), and thus exiting the cell. Image 14-14′ is the retroreflector image position (32) on the field mirror. The center view of FIG. 4 shows a side perspective of all ray (41) path progressions through the cell and the skew of angles in relation to the gas cell centerline axis (38). Image path overlays in the 2D projection include image 0/14′, 4/18, 8/22, 12/26, 24/10, 20/6, 16/2.

The right view shows pupil image stacks on upper (42) and lower objective mirrors (43), respectively.

The disclosed embodiment includes a retroreflector mirror implementation that builds on a concept first proposed by Horn and Pimentel. The original Horn and Pimentel design employs a retroreflector mirror to create additional columns of field stop images on the field mirror (18).

The disclosed embodiment employs a unique feature of a new retroreflector mirror to perpetuate the efficient field stop nesting pattern on the field mirror (18). The retroreflector geometry produces two additional nested columns of field images on the field mirror (18), significantly increasing path length while maintaining the high-density field stop nesting paradigm established by the unique cell geometry.

FIG. 4 also shows an example embodiment in which a retro plane defined by the image points 14 (98), 14′ (99), and (41) on top objective mirror (42), contains the centerlines of IR radiation of the retroreflection, and is skew to the orthogonal cell planes x, y, and z.

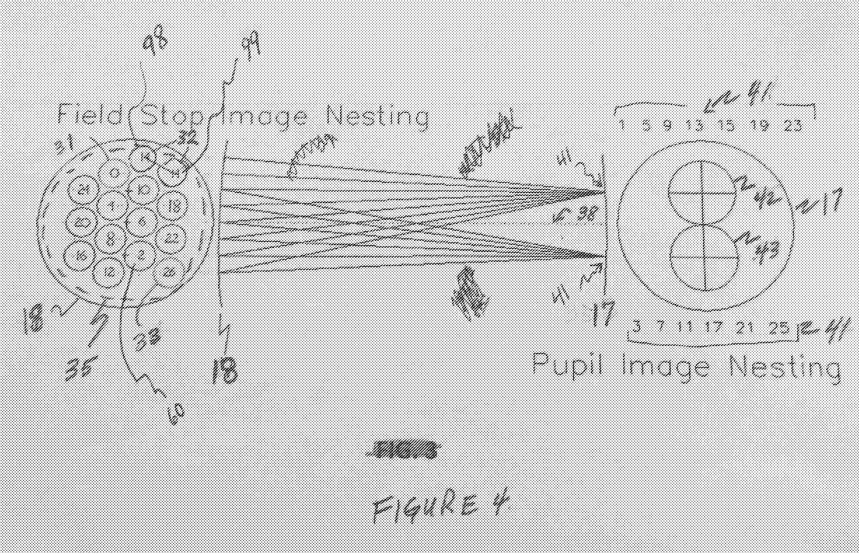

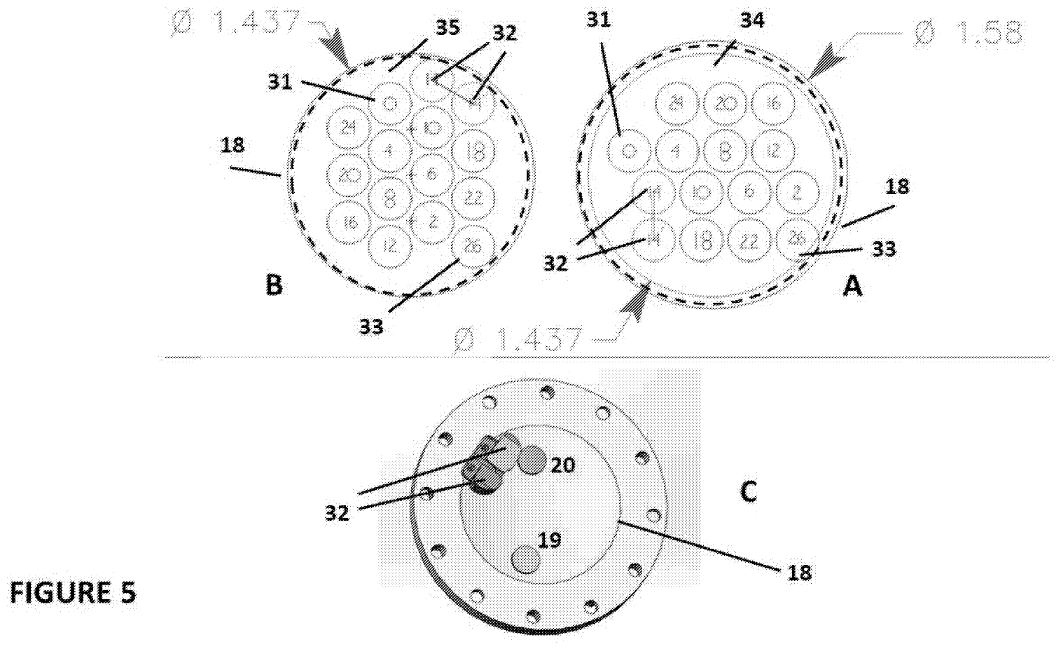

FIG. 5A shows the original field image pattern (34) created by the retroreflector mirror disclosed by Horn and Pimentel. The example shown is for a 26-pass cell. Image 14-14′ on the field mirror (18) is the location of the retroreflector mirror. Note that the vertical orientation of 14-14′ creates additional upper and lower field image rows that are tangent to the inner two rows. For example, images 12 and 16, and 6 and 22 are vertically stacked which results in less efficient use of the field mirror area. For the 26-pass cell described, the diameter of the image nest (34) for the prior art is 1.58 inches for the system field stop diameter used.

FIGS. 5B and 5C are two views of the field mirror (18) in the present embodiment. FIG. 5B is flipped relative to FIG. 5C for clarity. FIG. 5C shows a mechanical drawing of the field mirror (18), retroreflector (32), the input field lens (20) and the output field lens (19). In reference to FIG. 5B, the retroreflector (32) assumes a novel angular orientation geometry at field stop image position 14-14′. By maintaining the angular orientation of the nesting pattern (35), the nesting pattern of the two outer columns is consistent with the pattern established by the inner columns. Image 0 (31) is the position of the input field lens, image 26 (33) is the position of the output field lens.

A further unique design feature of this embodiment is the substitution of input and output field lenses (20,19) for standard input and output windows. Standard in the art is the use of IR transmitting windows to produce a seal. By placing each field lens at input/output field stop images, efficient relay of pupil images in and out of the cell is achieved. In this way efficient systemic optical matching of cell to source and detector fore-optics achieves requisite high optical throughput. For the 26-pass cell described, the diameter of the image nesting pattern (35) for the example embodiment is 1.437 inches for the system field stop diameter used. This particular example embodiment yields a 9% reduction in diameter of the nesting pattern (35).

FIG. 5C shows a perspective view of the field mirror (18) assembly showing the retroreflector mirror assembly (32), in this example, two 45° flat mirrors, and the input (20) and output (19) field lenses. Image 14-14′ is halfway between the two retroreflector flats. The retroreflector design geometry is such that image 14-14′ appears to have emanated from a new column of field stop images, thus creating the succession of outer column images. In addition, the second flat in the retro is geometrically oriented to send the pupil image directly back to the top objective mirror (42), thus maintaining the proper established succession of pupil images.

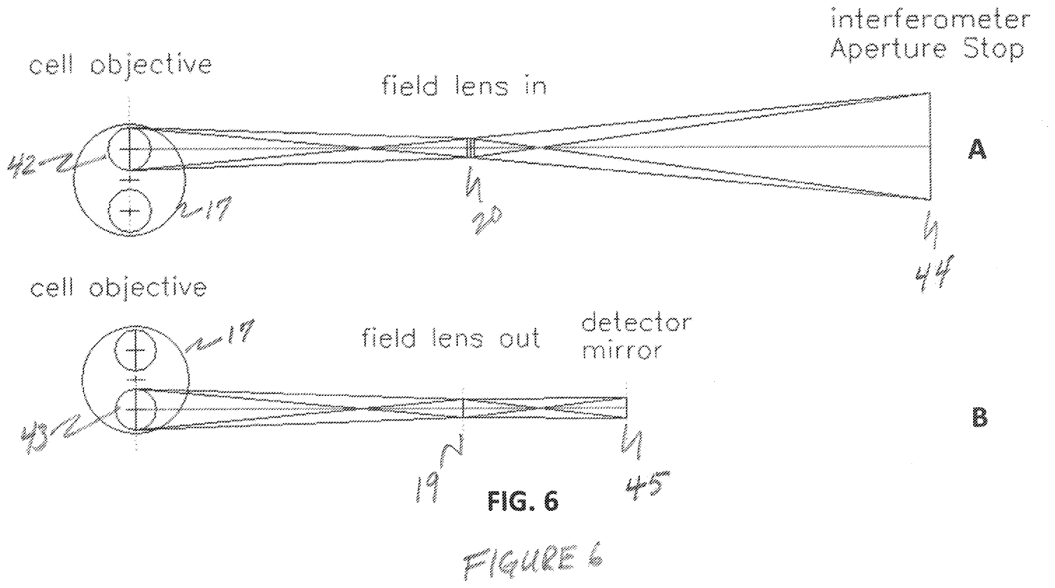

FIGS. 6A and 6B show schematic views of field lenses in place of standard input and output windows. FIG. 6A shows the input field lens (20) efficiently imaging the interferometer pupil (44) onto the top objective mirror (42) of the gas cell. FIG. 6B shows the output field lens (19) efficiently imaging the bottom cell objective (43) pupil onto the detector mirror (13). Optical matching of stops and pupils ensure efficient energy transfer and throughput optimization. The resulting high sensitivity facilitates rapid identifications at low sample concentrations. Furthermore, the high optical throughput allows the use of a room temperature IR detector that minimizes cost and power consumption.

In the particular example embodiment described, the angular orientation of the retroreflector (32), the use of lenses (20, 19) at field stop image positions at the input and output, the position of the input and output lenses in relation to retroreflector, and the input and output ray angles relative to the gas cell centerline axis yields more efficient use of the field mirror area. This results in a 21% reduction in gas cell volume for the same gas cell path length in relation to other designs.

### Electronics and Control Architecture

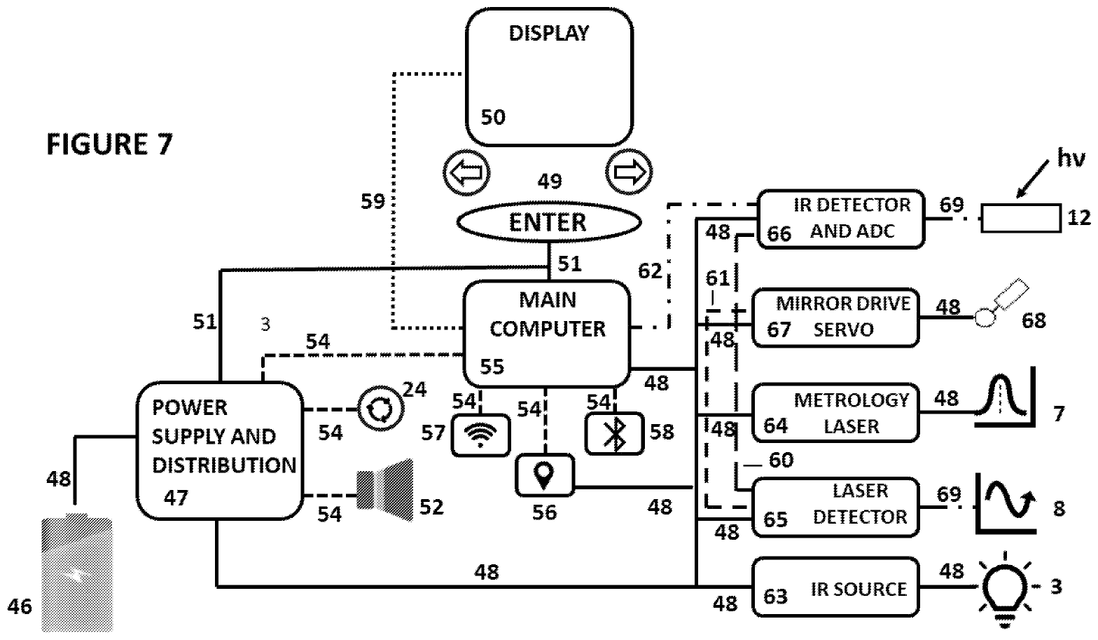

The electronics and methods for instrument control, power and output are shown in the schematic, FIG. 7. The instrument is powered by a battery, such as a rechargeable, internal battery (46). Alternatively, external power may be supplied, such as by mains power that is transformed to the appropriate DC voltage and amperage by a transformer. A power supply circuit (47) distributes power to other components or circuits, via the power distribution connections (48).

The user interface (UI) hardware consists of buttons (49) and a display screen (50). UI hardware connections (51) to the circuits facilitate instrument control and data analysis. Buttons (49) are used to turn the instrument on or off, select operational attributes, initiate data collection, observe data analysis results, and to navigate the software. Some functions are coordinated from the power supply circuit (47) including initiating an audible detection alarm speaker (52) and controlling the integrated pump (24) via control lines (54). Battery and other status indicators are accessed from the power supply circuit (47); status, output, and control connections (54) are made between the power supply (47) and main computer board (55).

A global positioning satellite (GPS) interface circuit (56) allows the determination of location information. Status, output, and control connections (54) are made between the GPS circuit and the main computer (55). A Wi-Fi™ (57) wireless internet connection and Bluetooth® (58) wireless connection are made to the main computer (55) via status, output, and control connections (54). Wi-Fi™ (57) allows the interface of the instrument to the internet for two-way communication. By interfacing to external software applications, data and analysis reports can be transmitted and shared and instrument status can be accessed. Bluetooth® facilitates short range transmission and sharing of data and analysis reports to external software applications.

The main computer (55) contains memory for the storage of collected data, spectral library signatures, the control and analysis software, standard graphics display hardware interfaces (59), and interfaces to system level components and functions that allow the control of the instrument, analysis of data, and display of results.

Several circuits contain the hardware and software protocols to control the interferometer. There is communication between instrument components, shown by connections (60,61) and a digital line connection (62) to the main computer (55). The IR source (3) output (4) is controlled by the IR source circuit (63). The metrology laser (7) output (9) is controlled by the laser control circuit (64). The laser detector (8) connects to the laser detector circuit (65) that contains the circuitry to detect the modulation of the metrology laser output (9) by the interferometer. This analog output (69) is passed to one channel of a 24-bit analog-to-digital converter on the detector circuit (66) over a connection (60). The laser interferogram is digitized for use in post processing the IR interferogram using the time-based laser interferogram as described in the U.S. Pat. No. 5,914,780 and Brault. Laser fringe zero crossings are used by the servo control circuit (67) to adjust the retroreflector mirror drive voltage (68). Laser fringe data is transmitted to the servo control circuit over a connection (61). The drive voltage drives the pendulum actuator that moves the pendulum assembly about the pivot (30). The IR detector circuit (66) also processes the IR signal interferogram that is transduced by the IR detector (12). The analog IR signal output (69) is passed to the IR detector circuit (66) The second channel of the delta-sigma ADC is used to digitize the IR interferogram as recorded by the IR detector (12), for use in processing according to U.S. Pat. No. 5,914,780 and Brault. The digitized IR and laser interferograms are passed to the main computer circuit over digital lines (62) for processing.

### Gas Sampling and Analysis

In one mode of use, the described analyzer can identify singular, discrete samples. This analysis mode, referred to as point measurement, is conducted in a manner similar to a conventional IR spectral analysis. First, a sample of clean air which does not contain the sample is measured as a reference. Then a sample of air containing the sample is measured. The analyzer produces an infrared spectrum of the sample free from instrument and atmospheric interferences. In one embodiment, infrared signatures of atmospheric components, instrument line shape and optical and electronic noise are removed from the sample spectrum using an unsupervised, adaptive data filtering process that can account for non-linear spectral responses. Identification of the resulting sample spectrum is accomplished by comparison to one or more IR spectral libraries. The library comparison can be optimized using multiple metrics, such as spectral fit, probability calculations, or correlation calculations. These comparison metrics can be further optimized through use of the full spectrum, weighting the comparison based on the reference or library data, or a combination of the two.

In a second mode of operation, the analyzer can function in a monitoring or survey mode. This mode, referred to as continuous measurement, uses a reference measurement similar to the point measurement mode; however, the reference is continually updated and compared to previously collected references. Each new infrared spectrum is compared to one or more libraries. If sufficient information is present to identify the unknown chemical, the algorithm can go into a detection mode where data can be co-added to increase the confidence in the detection result. If the collected IR spectra fall outside of statistical control of the reference, but sufficient data does not exist to identify the unknown sample, then the new data is used to update the existing reference. In this way the reference is always kept current while the detection mode continually monitors for an identifiable unknown sample. The identification of the unknown sample can be accomplished using the optimized search metrics specified in the single point measurement above.

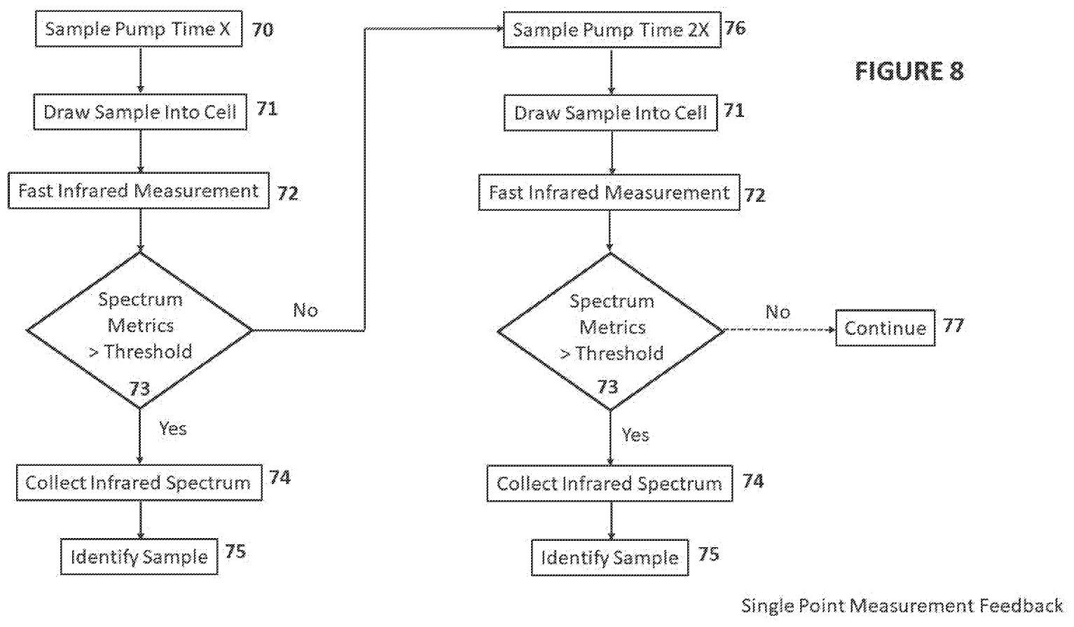

Identification of unknown materials by infrared spectroscopy requires an optimized signal intensity or signal-to-noise ratio (SNR). Insufficient signal (absorbance) does not provide enough spectral information for identification by library comparison. Likewise, excess signal creates a non-linear spectral response also resulting poor library comparisons. The disclosed gas and vapor analyzer can make use of a novel, integrated feedback loop between pump (24) operation, electronically activated valves integrated onto the gas cell, and the observed, analyzed IR signal. In point measurement, a reference or background spectrum is recorded in a known clean environment, free from chemical vapors. In reference to FIG. 8, when data collection is initiated, the integral pump (24) begins to draw sample (71) into the gas cell. The pump (24) operation time (70) is set to an initial value. An IR spectrum is recorded quickly (72) and referenced to the pre-recorded background, to compensate for atmospheric IR absorption by water and carbon dioxide. This quickly measured spectrum is evaluated for signal (absorbance) amplitude or other spectrum metrics (73). If the spectrum metrics are exceeded the analytical IR spectrum is recorded (74) and the identification of the chemical unknown in the ambient air proceeds (75). On the other hand, if the spectrum metrics are less than threshold, there is feedback to the pump (24) operation. The pump (24) operation time is increased (76), for example, doubled, and more sample is drawn into the cell (71). Again, an IR spectrum is recorded quickly (72) and referenced to the pre-recorded background, to compensate for atmospheric IR absorption by water and carbon dioxide. This quickly measured spectrum is evaluated for signal (absorbance) amplitude or other spectrum metrics (73). If the spectrum metrics are exceeded the analytical IR spectrum is recorded (74) and the identification of the chemical unknown in the ambient air proceeds (75). If the spectrum metrics are less than threshold, there is feedback to the pump (24) operation and the process is repeated (77), providing feedback to the pump (24), until there is sufficient IR signal amplitude for an identification to proceed. The absorbance signal intensity of the sample IR spectrum is continually monitored (73). The pump (24) is toggled in order to deliver the optimum amount of sample to fall within an absorbance window.

In continuous measurement, the cell valves are shut coincident with sufficient IR signal for identification being detected. In this way filling of the gas cell is stopped at the optimum signal level, preventing a non-linear spectral result from excessive signal. This allows detection of the minimum amount of sample independent of the concentration present. In each case, optimization of the pump (24) speed, cell volume and infrared collection time is required for the feedback loop to work successfully.

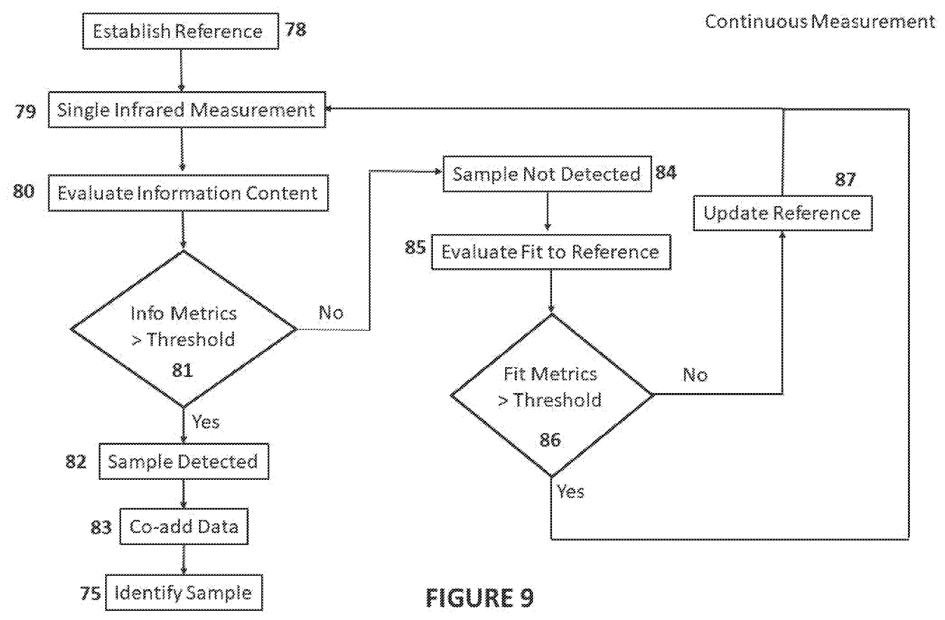

In the continuous mode of operation, the disclosed gas and vapor analyzer can function in a monitoring or survey mode. Referencing FIG. 9, the continuous measurement uses a reference or background measurement similar to the point measurement mode. An initial reference is established (78) and an IR spectrum is recorded quickly (79) and referenced to the pre-recorded background, to compensate for atmospheric IR absorption by water and carbon dioxide. Each single IR spectrum measured is compared to one or more IR spectral libraries and the information content evaluated (80) using statistical criteria for pattern matching. If the information metrics exceed a threshold (81), a sample detect is noted (82), additional spectra are co-added (83) to increase the SNR and finally the gas or vapor sample is identified (75). If the information metrics do not exceed a threshold (81), a sample non-detect is noted (84). Further analysis of the IR spectrum is performed. The IR spectrum is compared statistically to the reference (85). If the IR spectrum exceeds a fit metric and is statistically different than the established reference (78), then a new IR spectrum measurement (79) is initiated and the process is repeated. If the IR spectrum does not exceed a fit metric and is statistically not different than the established reference (78), the reference is updated with the newly recorded spectrum, then a new IR spectrum measurement (79) is initiated and the process is repeated.

In the continuous mode of operation, the reference is continually updated and compared to previously collected references. If sufficient information is present to identify the unknown chemical, the algorithm can go into a detection mode where data can be co-added to increase the confidence in the detection result. If the collected IR spectra fall outside of statistical control of the reference, but sufficient data does not exist to identify the unknown sample, then the new data is used to update the existing reference. In this way the reference is always kept current while the detection mode continually monitors for an identifiable unknown sample. The identification of the unknown sample can be accomplished using the optimized search metrics specified in the single point measurement above.

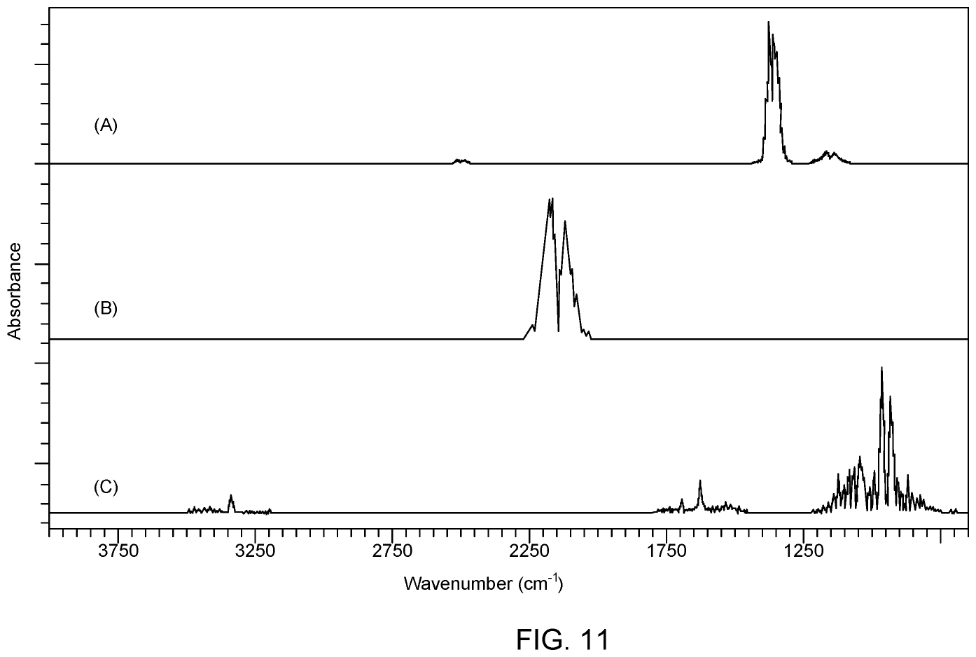

The integrated gas and vapor analyzer described here has the unique ability to accurately identify many different hazardous gases by comparison of the measured infrared spectrum of the sample gas to both commercial and customized spectral libraries. Spectral bands in infrared spectra are due to molecular vibrations of the interrogated sample. Each covalent chemical bond has a fundamental vibration; the majority of those vibrations occur in the infrared region from 4000-650 cm⁻¹ which is the region measured by this integrated gas and vapor analyzer. Each chemical bond has a unique vibrational frequency and corresponding unique infrared band. FIG. 11 demonstrates the specificity of infrared spectroscopy for identification of toxic gases by presenting spectra of (A) sulfur dioxide, (B) carbon monoxide, and (C) ammonia collected on the preferred embodiment of the gas and vapor identifier. Each of these chemicals is a Toxic Industrial Chemical (TIC) and of concern for public safety. The spectra are unique and easily distinguishable. Compared to infrared spectra of solid or liquid materials, these gas phase spectra demonstrate the narrow line shape and relatively few bands typically observed in gas phase infrared spectra. The integrated gas and vapor analyzer produces high signal to noise spectra of these and many other toxic gases, allowing for easy identification by library searching algorithms.

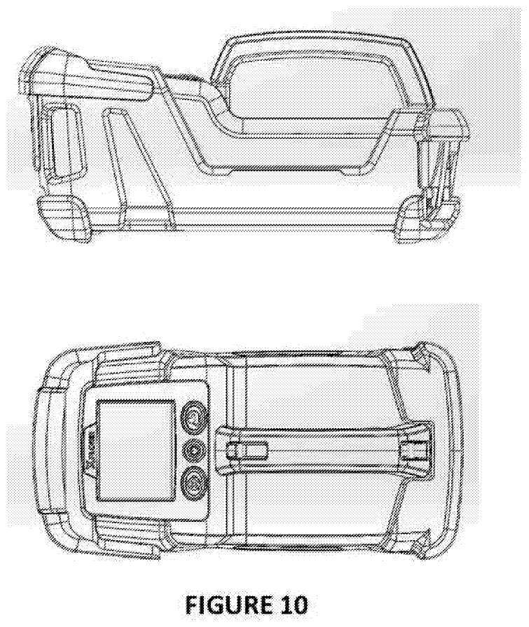

FIG. 10 shows line drawings of one example embodiment of a vapor and gas analyzer system employing a Fourier transform infrared spectrometer.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A handheld vapor and gas analyzer system including a Fourier transform infrared (FTIR) spectrometer, the system comprising:
an optical energy source adapted to provide an excitation signal;
an interferometer optically coupled to the optical energy source and adapted to modulate the excitation signal;
an infrared (IR) radiation detector adapted to transduce IR radiation into a modulated electrical signal;
a gas cell optically coupled to the interferometer, the gas cell comprising:
an input lens adapted to receive the modulated excitation signal and focus the modulated excitation signal within the gas cell,
an off-axis multiple reflection geometry adapted to receive the focused modulated excitation signal and pass the focused modulated excitation signal through a vapor phase specimen within the gas cell to generate an optical sample signal, wherein the off-axis multiple reflection geometry comprises a plurality of beam paths skewed relative to a longitudinal axis of the gas cell; and
an exit lens adapted to direct the optical sample signal from the gas cell to the IR radiation detector;
a pump adapted to introduce a gas or vapor phase specimen into the gas cell;
and
a controller adapted to identify detected gas and vapor samples based on the optical sample signal.

2. The handheld system of claim 1, wherein the interferometer of the FTIR spectrometer is a double pendulum.

3. The handheld system of claim 1, wherein the interferometer of the FTIR spectrometer comprises a linear actuator.

4. The handheld system of claim 1, wherein a photoionization detector (PID) samples the gas and vapor from the pump and detects ambient gases and vapors.

5. The handheld system of claim 4, wherein the pump is adapted to draw the vapor phase specimen into the PID.

6. The handheld system of claim 5 wherein the pump is adapted to draw the vapor phase specimen into the PID from the gas cell.

7. The handheld system of claim 4 wherein the pump is adapted to draw a second vapor phase specimen into the PID in parallel with the vapor phase specimen into the gas cell.

8. The handheld system of claim 4 wherein a second pump is adapted to draw a second vapor phase specimen into the PID.

9. The handheld system of claim 1, wherein the handheld system has a weight less than 10 pounds.

10. The handheld system of claim 1, wherein the handheld system is adapted to be operated using a single hand.

11. The handheld system of claim 1, wherein the handheld system is adapted to be operated via one or more buttons and a display.

12. The handheld system of claim 1, wherein a ratio of the gas cell volume to gas cell pathlength, is less than one or more of the group comprising 0.02, 0.03, and 0.04.

13. The handheld system of claim 1, wherein the controller comprises memory storing operating software, analysis software, and spectral libraries.

14. The handheld system of claim 1, wherein the interferometer comprises a double pendulum interferometer that self-corrects for perturbations due to shock or vibration incurred during the course of a spectrum recording cycle.

15. The handheld system of claim 1, wherein the input and output lenses in the gas cell are field lenses.

16. The handheld system of claim 1, wherein the controller is adapted to digitize and store a laser interferogram and an IR interferogram.

17. The handheld system of claim 16, wherein the stored interferogram data is post processed to correct for interferometer velocity perturbations.

18. The handheld system of claim 1, wherein the gas cell comprises a retroreflector mounted on the field mirror.

19. The handheld system of claim 18, wherein an axis of the retroreflector is geometrically oriented.

20. The handheld system of claim 19, wherein the retroreflector is geometrically oriented skew to x, y, and z planes of the gas cell such that a specific field image pattern is perpetuated on the field mirror, wherein one of the x, y, and z planes of the gas cell corresponds to a longitudinal axis of the gas cell.

21. A method for analyzing gases and vapors based on infrared (IR) spectroscopy, the method comprises:
providing an excitation signal;
modulating the excitation signal via an interferometer;
passing the modulated excitation signal through a gas cell comprising a gas or vapor phase specimen disposed within the gas cell to generate an optical sample signal, wherein the modulated excitation signal is directed by an off-axis multiple reflection geometry comprising a plurality of beam paths skewed relative to a longitudinal axis of the gas cell, wherein the modulated excitation signal enters the gas cell via an input lens and exits the gas cell via an output lens;
detecting the optical sample signal using an IR detector to transduce IR radiation of the optical sample signal into a modulated electrical signal; and
identifying the detected gas or vapor phase sample based on the optical sample signal.

22. The method of claim 21, wherein successive operations of identifying gas or vapor phase samples is made in either a point or continuous mode of operation.

23. The method of claim 22, wherein a pump adapted to draw the successive gas or vapor samples into the gas cell is controlled with a feedback loop based on an IR absorption signal.

24. The method of claim 22, wherein a stored reference or background is updated based on statistical metrics computed from the recorded IR absorption signal.

25. The method of claim 24, wherein the identity of gas or vapor is determined by comparison with stored library spectra.

26. The method of claim 22, wherein IR spectra are co-added to increase signal-to-noise ratio (SNR).

27. The method of claim 26, wherein statistical metrics are used to initiate co-adding of IR spectra to increase signal-to-noise ratio (SNR).

28. The method of claim 26, wherein statistical metrics are used to cease co-adding of IR spectra.

29. The method of claim 26, wherein statistical metrics are used to determine whether to initiate spectral library search to identify of an unknown chemical gas or vapor.

30. The method of claim 21, wherein statistical metrics are used to determine if a gas or vapor sample is detected or present.
